(19) United States
(12) Patent Application Publication
(10) Pub. No.: US 2006/0077467 A1
(43) Pub. Date: Apr. 13, 2006

(54) Error diffusion apparatus with cluster dot

(75) Inventor: Ki-min Kang, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/238,065

(22) Filed: Sep. 29, 2005

(30) Foreign Application Priority Data
Oct. 11, 2004 (KR) 2004-80788

(51) Int. Cl. G06F 15/00

(52) U.S. Cl. 358/3.03; 358/1.9

(57) ABSTRACT

Disclosed is an error diffusion apparatus with cluster dot. The error diffusion apparatus for performing an error diffusion on a second pixel based on a first pixel includes: a binary processing unit for binarizing a tone value of the first pixel based on a predetermined threshold; a binary error diffusion unit for computing a binary error value based on a difference between the tone value of the first pixel and a binary tone value for the first pixel, and reflecting the binary error value on a tone value of the second pixel applied to the binary processing unit; and a cluster forming unit for deciding whether to form a cluster for the first and second pixels, in reference to a predetermined cluster pattern and a binary tone value of the first pixel. The error diffusing apparatus reduces switching noises generated from the image forming process in pixel unit, and expands the tone value range of an image. In addition, the error diffusing apparatus prevents deteriorations in image quality by limiting the cluster size and restricting the cluster formation in the shadow and highlight areas of an image.

### CROSS-REFERENCE TO RELATED APPLICATIONS

This application claims the benefit under 35 U.S.C. § 119(a) of Korean Patent Application No. 2004-80788, filed on Oct. 11, 2004, the entire contents of which are incorporated herein by reference.

### BACKGROUND OF THE INVENTION

1. Field of the Invention

The present invention relates in general to an error diffusion apparatus. More specifically, the present invention relates to error diffusion clustering to form an image using pixels, thereby improving image characteristics.

2. Description of the Related Art

In general, image forming apparatuses such as printers, fax machines, copiers and printer/fax combos express images using a plurality of pixels. Electrophotographic, inkjet and bubble jet printing methods are some examples that the image forming apparatuses utilize for creating an image from an array of pixels. These methods are rooted in the same technology that uses a control signal or a pulse for each pixel in order to transfer a toner or ink onto a printing paper for image formation. Technical advances in recent years have now brought an error diffusion filter, which expresses a color tone of an image by the number of pixels per unit area and sets an array of pixels for improving characteristics of an image such as edge characteristics and pixel distribution.

FIG. 1 is a conceptual block diagram of a conventional error diffusion apparatus.

The error diffusion apparatus in FIG. 1 includes a first adder 10, a binary unit 20, a second adder 40, and an error diffusion unit 30.

The first adder 10 adds an input pixel x(m,n) to an output value of the error diffusion unit 30, and provides a result of the addition to the binary unit 20. Here, the tone value range of the pixel x(m,n) is between 0 and 255, ‘0’ representing the darkest tone and ‘255’ representing the brightest tone. The binary unit 20 compares a predetermined threshold such as tone value of 128 with an output value of the first adder 10, and converts the input pixel to a binary tone value. If the tone value of an input pixel is greater than the threshold, the binary unit 20 converts the input pixel to 255, and if not, 0. Thus, the converted binary tone value is either 0 or 255.

The second adder 40 adds an output tone value of the binary unit 20 from a tone value u(m,n) input to the binary unit 20 to obtain a difference therebetween, and provides a result to the error diffusion unit 30.

For example, assuming that the output tone value of the first adder 10 is 155, and the threshold of the binary unit 20 is 128, the output value of the binary unit 20 is 255. Thus, the output value of the second adder 40 becomes −100.

The error diffusion unit 30 applies a Floyed-Steinberg filter to the output value of the second adder 40. The Floyed-Steinberg filter renders weights to neighboring pixels of the pixel having the difference value provided from the second adder 40. Each of the neighboring pixels is given a different weight, and this causes error diffusion to the pixel having the tone value provided from the second adder 40.

FIG. 2 conceptually illustrates a weight application system of the error diffusion unit 30 in FIG. 1.

In FIG. 2, “*” indicates the position of a pixel converted to a binary tone value by the binary unit 20. As explained earlier, the error value of the pixel (*) is diffused by weights of 7/16, 5/16, 3/16 and 1/16 on the right side, lower side, lower left side and lower right side of the pixel (*), respectively.

FIGS. 3A to 3F conceptually represent images that are created or printed when the error diffusion apparatus of FIG. 1 is applied to a laser printer.

Here, FIGS. 3A to 3C illustrate images obtained under ideal conditions, and FIGS. 3D to 3F illustrate printed images obtained under normal conditions.

Specifically, FIG. 3A illustrates data for a binary image scanned to a photosensitive drum of a laser printer, FIG. 3B depicts a charge pattern that is focused on the photosensitive drum (OPC) corresponding to the binary image illustrated in FIG. 3A, and FIG. 3C illustrates a printed image on the paper.

Next, FIG. 3D illustrates data for a binary image scanned to a photosensitive drum of a laser printer, FIG. 3E depicts a charge pattern that is focused on the photosensitive drum (OPC) as opposed to the binary image illustrated in FIG. 3A, and FIG. 3F illustrates an image printed on the paper. As shown in FIG. 3D, when a laser beam is scanned onto the photosensitive drum to express a pixel, neighboring pixels of the target pixel are influenced by the energy of the laser beam. The influence gets stronger as the distance between pixels is shorter and a laser beam is scanned onto the photosensitive drum with greater frequency. For instance, images like the printed image of FIG. 3F are usually cross contaminated and deteriorate the image quality.

FIG. 4 illustrates one example of actual printed images that are affected by the laser beam energy discussed in relation to FIGS. 3D to 3F.

In the drawing, there are two dots, each dot being expressed in a pixel having a plurality of binary tone values. When a laser printer forms an image in a plurality of pixels onto a photosensitive drum and fixes a toner onto a printing paper, sometimes there is an area such as the area “A” of FIG. 4 for example, having certain tones due to the energy of a laser beam corresponding to each pixel, and not having 255 tones. This phenomenon occurs more often as the number of pixels forming each dot is increased, and reduces the range of tones that can possibly be expressed.

### SUMMARY OF THE INVENTION

It is, therefore, an object of the present invention to provide an error diffusion apparatus for clustering each pixel forming an image and increasing a range of expressible tones for an image, so that a high quality image can be obtained.

To achieve the above objects and advantages, there is provided an error diffusion apparatus for performing an error diffusion on a second pixel based on a first pixel. The apparatus comprises a binary processing unit for binarizing a tone value of the first pixel based on a predetermined threshold; a binary error diffusion unit for computing a binary error value based on a difference between the tone value of the first pixel and a binary tone value for the first pixel, and reflecting the binary error value on a tone value of the second pixel applied to the binary processing unit; and a cluster forming unit for determining whether to form a cluster for the first and second pixels, in reference to a predetermined cluster pattern and a binary tone value of the first pixel.

Preferably, the binary processing unit comprises a first adder for adding a tone value of the second pixel to a binary error value of the first pixel; and a binary unit for binarizing an output value of the first adder by the threshold.

Preferably, the error diffusing unit comprises a second adder for adding an output value of the first adder to an output value of the binary unit; and an error value computing unit for applying an error filter to the output value of the second adder and thereby, computing error values of neighboring pixels around the second pixel by weights.

Preferably, the error value computing unit is a predetermined error diffusion filter.

Preferably, if the first pixel and the second pixel are positioned in conformation to the cluster pattern, the cluster forming unit forms the first and second pixels in one cluster by increasing/decreasing the threshold for the second pixel.

Preferably, the cluster pattern sets predetermined positions of the first pixel with respect to the second pixel, in which the predetermined positions of the first pixel is one of the left side of the second pixel, the upper side of the second pixel, the left and upper sides of the second pixel, the left and upper left sides of the second pixel, the upper and upper left sides of the second pixel, the upper and upper right sides of the second pixel, the left and successive upper left sides of the second pixel, the left and successive upper left and upper sides of the second pixel, and the left and successive upper left, upper and upper right sides of the second pixel.

Preferably, if the first pixel is positioned in a diagonal direction away from the second pixel, the cluster forming unit does not cluster the first and second pixels.

Preferably, the cluster forming unit decreases the threshold in proportion to the size of a cluster formed of the first and second pixels.

Preferably, the cluster forming unit has the same probability distribution with a Gaussian function around the predetermined threshold, and increases/decreases the threshold for the second pixel according to the distribution function.

Preferably, the cluster forming unit decreases the threshold in proportion to a different cluster size by the cluster pattern.

### BRIEF DESCRIPTION OF THE DRAWINGS

The above aspects and features of the present invention will be more apparent by describing certain embodiments of the present invention with reference to the accompanying drawings, in which:

FIG. 1 is a block diagram illustrating a conventional error diffusion apparatus;

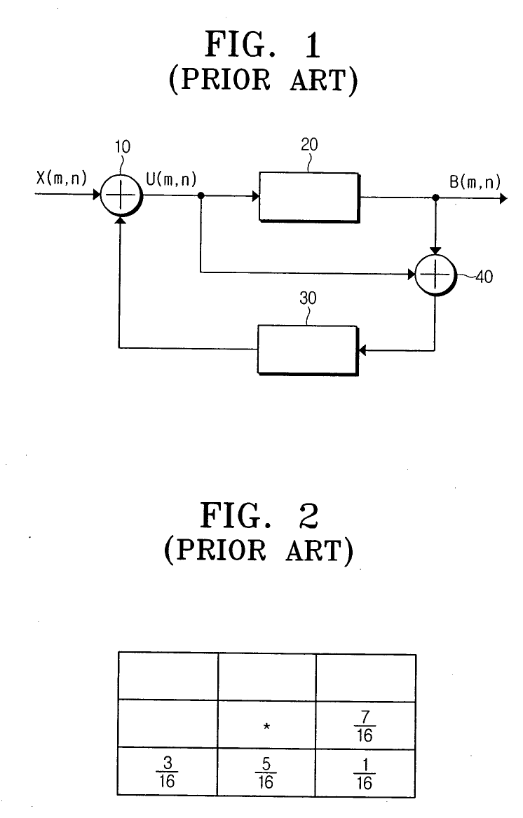

FIG. 2 is a diagram illustrating a conventional weight application system of an error diffusion unit in FIG. 1;

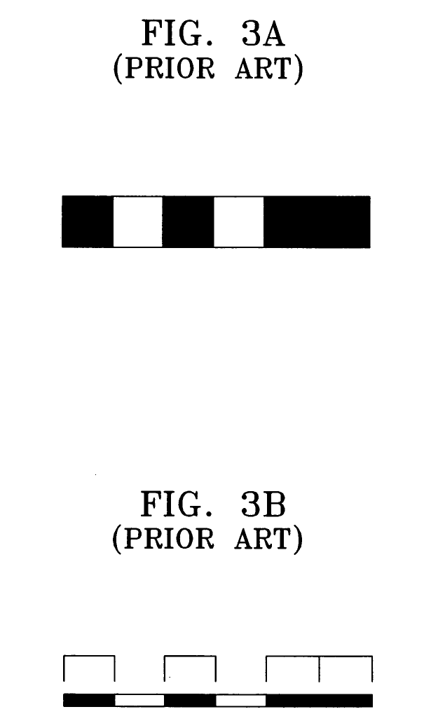

FIGS. 3A to 3F are diagrams illustrating images that are created or printed when an error diffusion apparatus of FIG. 1 is applied to a conventional laser printer;

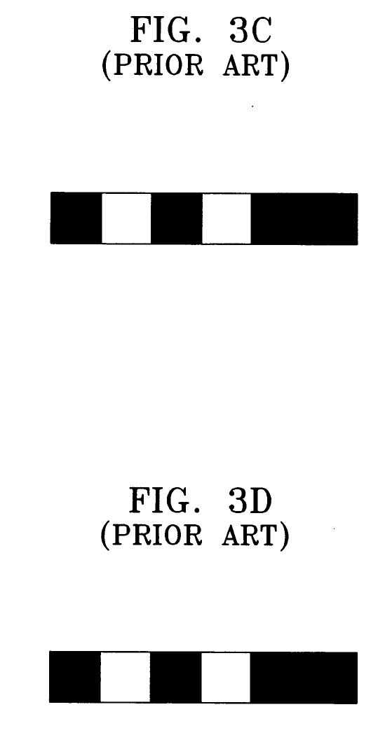

FIG. 4 is a diagram illustrating one example of printed images affected by a laser beam energy which is described in relation to FIGS. 3D to 3F according to a conventional method;

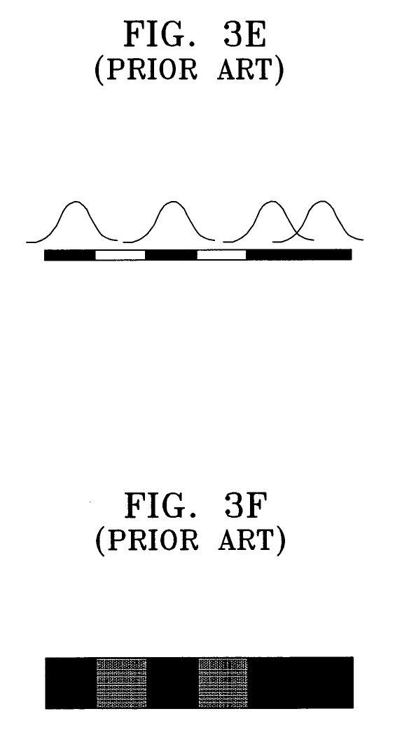

FIG. 5 is a block diagram illustrating an error diffusion apparatus according to an embodiment of the present invention;

FIGS. 6A to 6P are diagrams illustrating examples of cluster patterns provided to a cluster forming unit in FIG. 5;

FIG. 7 is a graph illustrating a relationship between cluster sizes and correction values (ΔT(m,n)); and

FIG. 8 is a graph illustrating a relationship between tone values and correction values of a pixel.

Throughout the drawings, the same or similar elements, features and structures are represented by the same reference numerals.

### DETAILED DESCRIPTION OF EXEMPLARY EMBODIMENTS

An exemplary embodiment of the present invention will be described herein below with reference to the accompanying drawings.

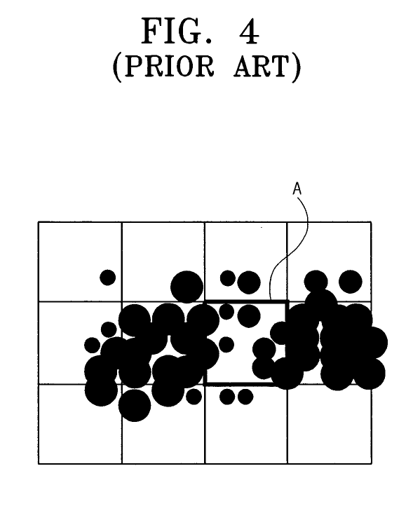

FIG. 5 is a conceptual block diagram of an error diffusion apparatus in accordance with an embodiment of the present invention.

Referring to FIG. 5, the error diffusion apparatus comprises a binary processing unit 100, a cluster forming unit 200, and a binary error value computing unit 300.

The binary processing unit 100 converts a tone value of an input pixel x(m,n) to one of tone values between 0 and 255 using a predetermined threshold Tref. The tone value ‘0’ represents the darkest tone, whereas the tone value ‘255’ represents the brightest tone. Preferably, the threshold Tref has a tone value of 128 in the medium range of 0-255. If the tone value of an input pixel x(m,n) is smaller than the threshold Tref, the binary processing unit 100 converts and outputs the tone of the pixel as ‘0’, and if not, ‘255’.

The cluster forming unit 200 has a predetermined cluster pattern, and determines whether to form a cluster among the pixels, on the basis of the cluster pattern. If a result of the determination is that neighboring pixels have good positions suitable for the cluster pattern and have the same binary tone value, the cluster forming unit 200 forms those pixels into one cluster. In this manner, it becomes possible to prevent deteriorations in image characteristics caused by a laser beam scanning on each pixel through on/off switching processes. That is, when a laser beam undergoes on/off switching processes, the cluster forming unit 200 minimizes interferences among pixels caused by the energy of the laser beam for each pixel.

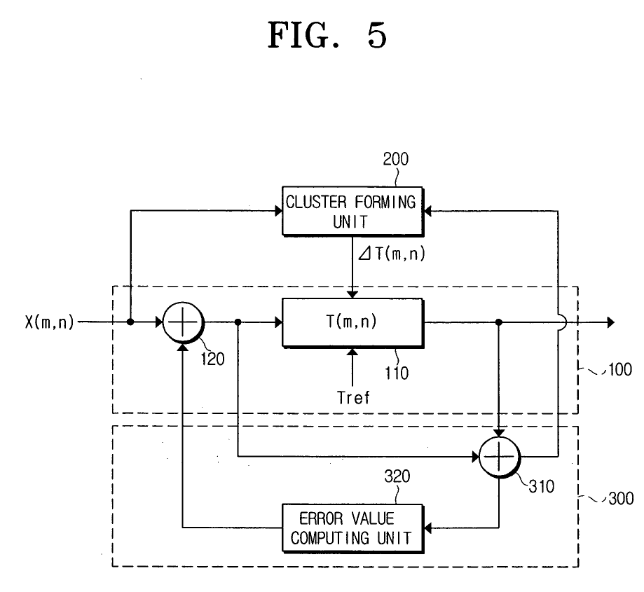

FIGS. 6A to 6P are diagrams illustrating examples of cluster patterns provided to the cluster forming unit 200.

For convenience all pixels shown in FIG. 6 are shown as having an exemplary 3×3 grid structure. The black shaded areas indicate pre-processed pixels, and areas with *s indicate post-processed pixels. Hereinafter, the pre-processed pixels will be referred to as first pixels, and the post-processed pixels will be referred to as second pixels, respectively. Here, the first pixels refer to pixels that are processed by the error diffusion apparatus before the second pixels, and there can be more than one pre-processed pixel. The cluster patterns will now be described in greater detail in reference to FIGS. 6A to 6P.

FIG. 6A shows that the first pixel is provided on the left side of the second pixel;

FIG. 6B shows that the first pixel is provided above also known as on the upper side of the second pixel;

FIG. 6C shows that the first pixels are provided on the left and upper sides of the second pixel, respectively;

FIG. 6D shows that the first pixels are provided on the left and upper left sides of the second pixel, respectively;

FIG. 6E shows that the first pixels are provided on the upper and upper left sides of the second pixel, respectively;

FIG. 6F shows that the first pixels are provided on the upper and upper right sides of the second pixel, respectively;

FIG. 6G shows that the first pixels are provided on the left and successive upper left sides of the second pixel;

FIGS. 6H, J, K, N and O show that the first pixels are provided on the left, and successive upper left and upper sides of the second pixel; and

FIGS. 6 I, J, M and P show that the first pixels are provided on the left, and successive upper left, upper and upper right sides of the second pixel.

As can be seen in FIGS. 6A to 6P, when the first pixel and the second pixel are in a diagonal direction, they cannot be clustered. This is because when the first pixel and the second pixel are in a diagonal direction, the correlation between the two pixels is reduced and there is a high possibility that the diagonal positions of the pixels are influenced by external noise.

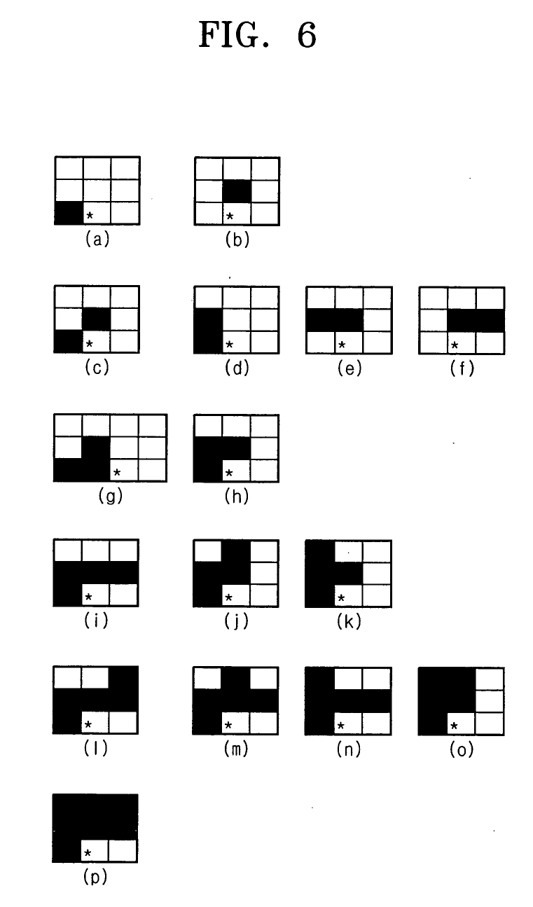

Meanwhile, when the first pixel and the second pixel are clustered, the resolution of an image is usually reduced in proportion to the cluster size. For instance, the resolution of an image in a relatively large cluster unit is lower than the resolution of an image in a small pixel unit. Therefore, when the cluster forming unit 200 of the present invention forms the first pixel and the second pixel in a cluster according to the cluster patterns illustrated in FIGS. 6A to 6P, it increases/decreases a correction value (AT(m,n)) being provided to the binary unit 110, so that the cluster size formed in the binary processing unit 100 can be limited. More details on this will be provided in reference to FIG. 7.

FIG. 7 graphically shows a correlation between cluster sizes and correction values (ΔT(m,n)). In particular, the graph in FIG. 7 shows a correlation between the cluster size and the shape strength (Shape_strength), which is a variable determining the magnitude of the correction value (ΔT(m,n)). The variable (Shape_strength) decreases proportionally to the cluster size, and by reducing the correction value (ΔT(m,n)) it is possible to control the distribution of binary tone values from the binary processing unit 100 to be 255, making output images brighter. This means that the distribution of clustered black shaded pixels (tone value of 0) is reduced.

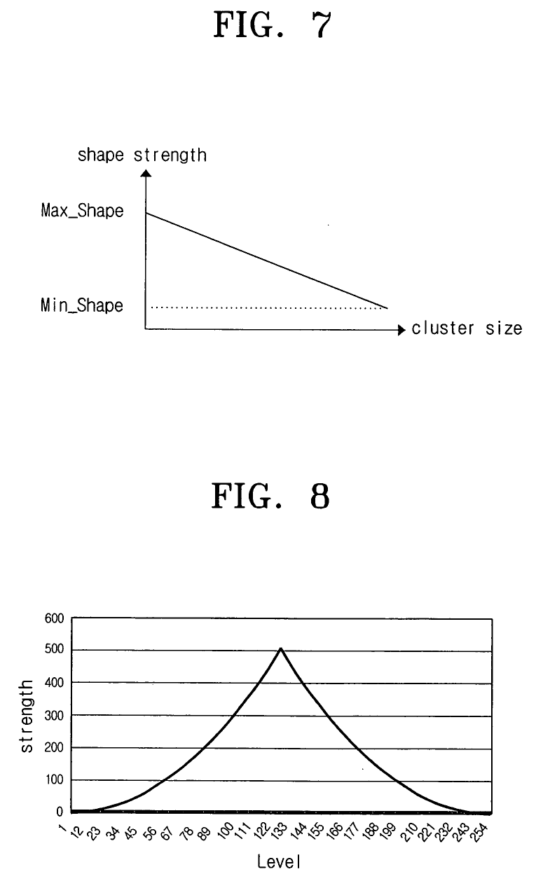

In case of clustering the first pixel and the second in one cluster, it can be unnatural to form the cluster in a shadow area or a highlight area. For instance, if a large cluster is formed in a highlight area of an image, the image looks unnatural and it is not necessary to form a cluster in a shadow area. As such, the cluster forming unit 200 according to the embodiment of the present invention has an additional function of determining whether or not to form a cluster according to the tone value of an input pixel. More details on this will be provided in reference to FIG. 8.

FIG. 8 is a graph showing the correlation between tone values and correction values of a pixel. As can be seen in FIG. 8, the graph has a probability distribution similar to a Gaussian function. Thus, the parameter (strength) that adjusts the magnitude of the correction value (ΔT(m,n)) according to the tone value of an input pixel is normally distributed being increased and decreased around the median tone value (e.g., tone value of 128). When the tone value of an input pixel is greater or smaller than the medium tone value, the strength is decreased, and by reducing the correction value (ΔT(m,n)) provided from the cluster forming unit 200 to the binary unit 110 it is possible to control the distribution of binary tone values output from the binary processing unit 100 to be 255, making output images brighter. This means that the distribution of clustered black shaded pixels (tone value of 0) is reduced.

Referring to FIG. 5, preferably, the binary processing unit 100 comprises a first adder 120 and a binary unit 110.

The first adder 120 adds an input pixel x(m,n) to an output value of the binary error value computing unit 300, and provides a result of the addition to the binary unit 110. Herein, the pixel x(m, n) has tone values ranging from 0 to 255. The binary unit 110 compares a predetermined threshold Tref to the output value of the first adder 120, and converts the input pixel to a binary tone value. If the tone value of an input pixel is greater than the threshold Tref, the binary unit 110 converts the input pixel to 255, and if not, 0. Here, the binary unit 110 increases/decreases a threshold Tref by the correction value (ΔT(m,n)) provided from the cluster forming unit 200, in order to ensure that the cluster size is not increased excessively or the cluster is not easily formed in the shadow area and the highlight area of an image.

The second adder 310 adds an output tone value of the binary unit 20 from a tone value u(m,n) input to the binary unit 20 to obtain a difference therebetween, and provides a result to the error value computing unit 320.

For example, suppose that the output tone value from the first adder 10 is 155, and the threshold of the binary unit 110 is 128. In this case, since the output value of the binary unit 110 is 255, the output value of the second adder 310 becomes −100.

The error value computing unit 320 applies an exemplary filter such a Floyed-Steinberg filter to the output value of the second adder 310. The Floyed-Steinberg filter renders weights to neighboring pixels of the pixel having the difference value provided from the second adder 310. Each of the neighboring pixels is given a different weight, and this causes error diffusion to the pixel having the tone value provided from the second adder 310. In order to diffuse the error value, the Floyed-Steinberg filter renders weights of 5/16, 3/16, 7/16 and 1/16 on the lower, lower left, right and lower right sides of the pixel (*), respectively. The diffused error value is provided to the first adder 120. Then, the first adder 120 adds a weight-applied error value to the target pixel and provides the result to the binary unit 110.

As described above, the embodiment of the present invention clusters each pixel that forms an image. As a result, switching noises generated from the image forming process in the pixel unit can be greatly reduced, and the tone value range of an image is expanded. In addition, the embodiment of the present invention can be advantageously used for preventing deteriorations in image quality by limiting the cluster size and restricting the cluster formation in the shadow and highlight areas of an image.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. An error diffusion apparatus for performing an error diffusion on a second pixel based on a first pixel, the apparatus comprising:
a binary processing unit for binarizing a tone value of the first pixel based on a predetermined threshold;
a binary error diffusion unit for computing a binary error value based on a difference between the tone value of the first pixel and a binary tone value for the first pixel, and reflecting the binary error value on a tone value of the second pixel applied to the binary processing unit; and
a cluster forming unit for determining whether to form a cluster for the first and second pixels, in reference to a predetermined cluster pattern and a binary tone value of the first pixel.

2. The apparatus according to claim 1, wherein the binary processing unit comprises:
a first adder for adding a tone value of the second pixel to a binary error value of the first pixel; and
a binary unit for binarizing an output value of the first adder by the threshold.

3. The apparatus according to claim 2, wherein the error diffusing unit comprises:
a second adder for adding an output value of the first adder to an output value of the binary unit; and
an error value computing unit for applying an error filter to the output value of the second adder and thereby, computing error values of neighboring pixels around the second pixel by weight.

4. The apparatus according to claim 3, wherein the error value computing unit is a predetermined error diffusion filter.

5. The apparatus according to claim 1, wherein, if the first pixel and the second pixel are positioned in conformation to the cluster pattern, the cluster forming unit forms the first and second pixels in one cluster by increasing/decreasing the threshold for the second pixel.

6. The apparatus according to claim 5, wherein the cluster pattern sets predetermined positions of the first pixel with respect to the second pixel, the predetermined positions of the first pixel being one of the left side of the second pixel, the upper side of the second pixel, the left and upper sides of the second pixel, the left and upper left sides of the second pixel, the upper and upper left sides of the second pixel, the upper and upper right sides of the second pixel, the left and successive upper left sides of the second pixel, the left, and successive upper left and upper sides of the second pixel, and the left, and successive upper left, upper, and upper right sides of the second pixel.

7. The apparatus according to claim 6, wherein, if the first pixel is positioned in a diagonal direction away from the second pixel, the cluster forming unit does not cluster the first and second pixels.

8. The apparatus according to claim 5, wherein the cluster forming unit decreases the threshold in proportion to the size of a cluster formed of the first and second pixels.

9. The apparatus according to claim 5, wherein the cluster forming unit has the same probability distribution with a Gaussian function around the predetermined threshold, and increases/decreases the threshold for the second pixel according to the distribution function.

10. The apparatus according to claim 1, wherein the cluster forming unit decreases the threshold in proportion to a different cluster size by the cluster pattern.

11. A method for performing error diffusion on a second pixel based on a first pixel, the method comprising:
binarizing a tone value of the first pixel based on a predetermined threshold;
computing a binary error value based on a difference between the tone value of the first pixel and a binary tone value for the first pixel, and reflecting the binary error value on a tone value of the second pixel applied to the binary processing unit; and
determining whether to form a cluster for the first and second pixels, in reference to a predetermined cluster pattern and a binary tone value of the first pixel.

12. The method according to claim 11, wherein the step of binarizing comprises:
adding a tone value of the second pixel to a binary error value of the first pixel; and
binarizing an output value of the first adder by the threshold.

13. The method according to claim 11, wherein the step of binarizing comprises:
adding an output value of the first adder to an output value of the binary unit; and
applying an error filter to the output value of the second adder and thereby, computing error values of neighboring pixels around the second pixel by weight.

14. The method according to claim 11, further comprising:
forming the first and second pixels in one cluster by increasing/decreasing the threshold for the second pixel if the first pixel and the second pixel are positioned in conformation to the cluster pattern.

15. The method according to claim 11, wherein the step of determining comprises:
decreasing the threshold in proportion to the size of a cluster formed of the first and second pixels.
